(19) United States
(12) Patent Application Publication
(10) Pub. No.: US 2010/0108792 A1
(43) Pub. Date: May 6, 2010

(54) BLOCK DRESSING MACHINE

(76) Inventor: Bradley J. Price, Rochester, MN (US)

Correspondence Address: Moore & Hansen, PLLP, 225 South Sixth Street, Suite 4850, Minneapolis, MN, 55402, US

(21) Appl. No.: 12/262,757

(22) Filed: Oct. 31, 2008

(51) Int. Cl. B02C 19/00

(52) U.S. Cl. 241/101.5; 241/283; 241/186.35

(57) ABSTRACT

A machine for dressing externally viewable surfaces of a building block. The machine includes transport section and a block modifying section. The transport section engages a building block and the block modifying section dresses the viewable surfaces of the block. The transport section and the block modifying section are moved in a linear direction, relative to each other. The block modifying section is able to dress an entire viewable surface of a block or selected portions of a block. The block modifying section includes block modifier units that have different operational characteristics and motions. One block modifier unit operates in a reciprocating fashion and another block modifier unit operates in a rotary fashion. The different block modifier units are used on different viewable surfaces of a block and may be used alone or in conjunction with each other to produce building blocks having differently dressed viewable surfaces.

### BACKGROUND

This application relates generally to machines used to fabricate building blocks. More particularly, this application relates to a machine for dressing externally viewable surfaces of blocks used to construct retaining walls, free-standing walls, paved surfaces, and the like.

Building blocks are widely used in a variety of applications, and can be used to retain soil, as fences, as structural components of buildings, as sidewalk surfaces, and as road surfaces. A particular style of building block that is increasing in popularity is the rustic or weathered look. Rustic or weathered look blocks are desirable for several reasons. They convey the impression of craftsmanship that is nowadays frequently absent. They convey a sense of security and stability. And, they are visually pleasing to an observer.

A variety of approaches have been used to create rustic appearing blocks. The most elementary and straightforward approach is to take a molded block and hand dress or roughen the surface using hammer and chisel. Another approach has been to provide a patterned mold that is able to simulate a rustic surface. Unfortunately, while it eliminates the step of hand dressing, a user is more-or-less stuck with the product as it comes from the mold. Any modification thereafter would defeat the purpose of such a block. Another approach is to take a molded block and place it in a rotatable container that tumbles it about (preferably, with other blocks or suitable material). The problem with this approach is that as a block is being tumbled, all of the exterior surfaces, including critical locater protrusions and mating surfaces, are being ground down. If the protrusions are knocked off or damaged during the tumbling process, the ability to interlock and/or provide proper spacing is compromised. Another approach attempts to form rustic surfaces by splitting a block into smaller segments along a predetermined plane. This creates two blocks, each with a front face that has the appearance of a natural split rock. While attractive, the split surfaces do not convey the impression that they were hand worked. Yet another approach uses flails to modify the externally viewable surfaces of blocks. Typically, the flails comprise short sections of chain one end of which is affixed about the perimeter of a rotatable shaft, the other end of which may be provided with an enlarged head of steel or other similar material. In operation, the flail ends (with the enlarged heads as the case may be) strike the entire front surface of a block as they are swung about by the rotatable shaft.

### SUMMARY

In one embodiment, a machine works externally viewable surfaces of building blocks so that they appear to have been hand dressed. For purposes of this application, the term block (or masonry block) is intended to include any naturally occurring material, manmade material, molded cementitious block, natural and artificial stone or like material that may be used for buildings, indoor walls, partitions, facades, retaining walls, walkways, freestanding walls or fences, capstones, pavers, or other similar structures, with or without the use of mortar or its functional equivalents.

In a preferred embodiment, the machine comprises a main frame, a transport section, and a block modifying section. The main frame is constructed and arranged to support the transport section, which comprises a movable support portion and a stabilizer portion. The movable support portion includes an upper surface upon which one or more blocks may be positioned. An inboard fence, located adjacent to one side of the movable support portion, serves as a guide for a block as it is moved through the transport section. Preferably, the movable support portion is oriented so that it is substantially horizontal. The stabilizer portion is located above the movable support portion and is vertically adjustable relative thereto. The movable support portion and the stabilizer portion are configured so that they are able to contact external surfaces of one or more blocks moved by the transport section. Preferably, the movable support portion and the stabilizer portion are configured to contact opposing external surfaces of a block so as to effectively grip a block being processed. The gripping ability of the transport section is enhanced by providing the stabilizer portion with one or more biasing elements that exert a force towards the movable support.

A block modifying section is located to one side of the transport section and comprises one or more primary modifiers that have one or more hammer elements. The one or more hammer elements are configured and arranged to be actuated in a direction that is generally orthogonal to the side of the transport section. Preferably, with each primary modifier, there is a plurality of hammer elements arranged in a matrix or array. The hammer elements are attached to a housing so as to form a block modifying unit or module, which is operatively connected to a platform. The platform may be adjustably positioned relative to the transport section. Preferably, there are approximately 7 to approximately 15 hammer elements in each unit or module. Additionally, the unit or module may be angularly positioned relative to the transport section. Two or more units or modules may be positioned adjacent each other in a side-by-side relation. As will be appreciated, the two units act in concert with each other and are arranged so that they are in a vertically staggered relation. As will be appreciated, when a block of material is moved relative to the primary modifiers, the impact zones of the hammer elements will preferably overlap. Preferably, one end of the platform that holds the block modifying units is operatively connected to either the main frame or the movable support portion, while the other end of the platform is operatively connected to the stabilizer portion. When the stabilizer portion moves vertically relative to the main frame (and the movable support portion connected thereto), the position of the primary modifiers is automatically adjusted. In operation the hammer elements, which may have independent motion, are able to strike and impact a surface of a block in a vibratory fashion as the block is being moved relative to the primary modifiers.

The block modifying section of the machine may also be provided with one or more secondary modifiers. The secondary modifiers may be used to dress the edges or arrises of the block so as to produce irregular edges. A preferred secondary modifier comprises a pair of rotatable drums. Each drum is provided with a plurality of radially extending teeth that are spaced about the surface of the drum and which are rigidly attached thereto. Preferably, the teeth have at least one impacting surface and are arranged in one or more circumferential rows, spaced axially from each other along the rotational axis of the drum. Preferably, the teeth in each circumferential row are evenly spaced from each other. And, preferably, adjacent circumferential rows of teeth are offset from each other. The rotatable drums are operatively connected to the main frame (or the movable support portion) and the stabilizer portion of the transport section, so that as the stabilizer portion is raised and lowered the upper drum automatically maintains its position to accommodate differently sized blocks. Preferably, the rotatable drums and are situated so that they may work several disparate, viewable edge sections of a block before it reaches the primary modifiers.

Another embodiment of a secondary modifier includes one or more sub-units or sub-modules have one or more hammer elements. The hammer elements are configured and arranged to be actuated in a direction that is generally perpendicular to the longitudinal axis of the transport section. Preferably, the hammer elements of each sub-unit or module are arranged in a matrix or array. The hammer elements are attached to a housing, which is movably attached to a bracket and the bracket may be adjustably positioned relative to the transport section. Additionally, the sub-unit or module may be angularly positioned relative to the transport section. Two or more sub-units or modules are positioned so that they are able to work one or more arrises or edges of a block. In operation the hammer elements, which may have independent motion, are able to strike and impact selected portions of a block as it is being moved by the transport section of the machine. Preferably, the sub-units or modules and are situated so that they may work several disparate, viewable edge sections of a block after it passes the primary modifiers. However, it will be understood that the sub-units or modules may be positioned before the primary modifiers, if desired.

The machine includes an inboard fence and adjustable outboard fences. The inboard fence, positioned along one side of the movable support portion, guides a block as it moves through the machine. A preferred embodiment of an outboard fence comprises a flexible, endless belt that is positioned about the rotatable elements and held in tension due to the spring-biased arms. In use, the outboard fence is located adjacent to and slightly above the surface of the movable support portion so that the belt (and the spring biased rotatable elements) is able to contact the rear (or non-worked) surfaces of one or more blocks as they are being processed by the machine. Preferably, the outboard fence may be adjustably positioned towards and away from the transport section so as to accommodate different sized blocks.

In an alternative embodiment, the outboard fence comprises an elongated body that includes first and second ends, a first or horizontal wall, and a second or vertical wall. Preferably, the fence is movably positionable relative to the inboard fence so as to accommodate blocks having different depths (the z dimension in a three dimensional coordinate system).

The machine may be provided with an optional upper outboard fence that is associated with the stabilizer portion of the transport section. The upper fence comprises an elongated body that includes first and second ends, a first or horizontal wall and a second or vertical wall. The upper fence may include a third wall that is connected to the first and second walls, and which is angled relative thereto. The third wall presents a surface that can guide a block by contacting an upwardmost extending rear edge thereof. The position of the upper outboard fence may be adjusted in the y and z directions in a three dimensional coordinate system to accommodate blocks having different heights and depths.

The above machine may be used with a wide variety of preformed building blocks having a wide variety of sizes and surface textures. And, with a single machine, it is possible to work a single or multiple areas of an exterior surface. However it is envisioned that two single surface machines can be connected to each other in an end-to-end manner so that the output end of a first machine confronts the input end of the second machine, and so that the block modifying section of the first machine and the block modifying section of the second machine face work opposite surfaces of a block.

The machines described here are able to dress externally viewable surfaces of a building block, increase the speed at which rustic masonry blocks may be fabricated, and use a transport section to effectively grip one or more blocks as they are processed by the machine.

These machines have a block modifying section that includes one or more hammer elements that percussively engage an externally viewable surface of a block. They may be adjusted to provide different knapping depths, or to accommodate differently sized blocks.

An advantage of the machines is that externally viewable surfaces of a block may be randomly impacted by a plurality of hammer elements whose impact zones overlap.

Another advantage is that various externally viewable surfaces of a block may be selectively processed.

A third advantage is that the machines are able to accommodate a variety of differently shaped blocks.

Yet another advantage of the invention is that a plurality of building blocks may be dressed in an expedient and efficient manner.

These and other objectives, features and advantages will appear more fully from the following description, made in conjunction with the accompanying drawings wherein like reference characters refer to the same or similar parts throughout the several views. And, although the disclosure hereof is detailed and exact, the physical embodiments herein disclosed are merely examples that may be embodied in other specific structures. While preferred embodiments have been described, the details may be changed without departing from the claims.

### DESCRIPTION OF THE DRAWINGS

FIG. 1 is a perspective representation of an embodiment of a block dressing machine;

FIG. 2 is a front elevational view of the block dressing machine of FIG. 1;

FIG. 3 is a left side elevation view of the block dressing machine of FIG. 1;

FIG. 4 is a right side elevational view of the block dressing machine of FIG. 1;

FIG. 5 is a top plan view of the block dressing machine of FIG. 1;

FIG. 6a is a front perspective view of the stabilizer portion and the crossbeam or carriage of FIG. 1;

FIG. 6b is a rear perspective view of the stabilizer portion and the crossbeam or carriage of FIG. 1;

FIG. 7 is a partial perspective view of the movable support portion of the transport section, primary and secondary block modifiers, and the outboard and inboard fences of FIG. 1;

FIG. 8a is a skeletonized, front elevational view of a block modifying section;

FIG. 8b is a top plan view of FIG. 8a;

FIG. 9 is a front elevational view of primary modifier units attached to a platform;

FIG. 10a is a perspective view of a primary modifier;

FIG. 10b is a front plan view of the primary modifier of FIG. 10a;

FIG. 10c is a side elevational view of the primary modifier of FIG. 10a;

FIG. 10d is a top plan view of the primary modifier of FIG. 10a;

FIG. 11 is a perspective view of an alternative secondary block modifiers as they may be positioned adjacent the movable support and stabilizer portions of the transport section;

FIG. 12 is a perspective view of an embodiment of a fence; and

FIG. 13 is a perspective view of another preferred embodiment.

### DETAILED DESCRIPTION

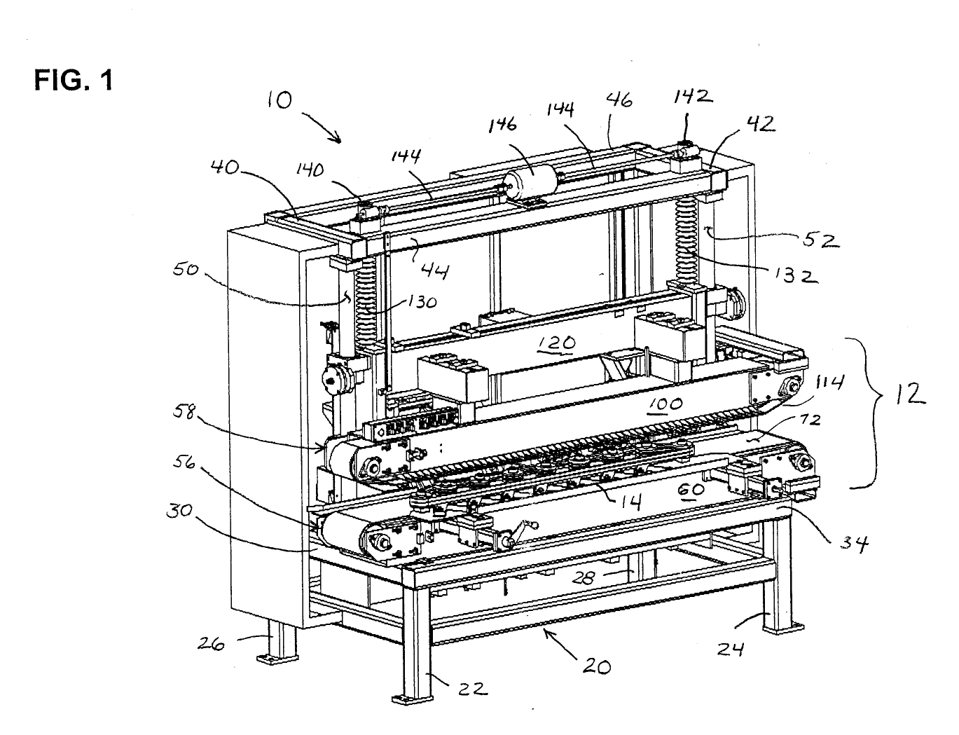

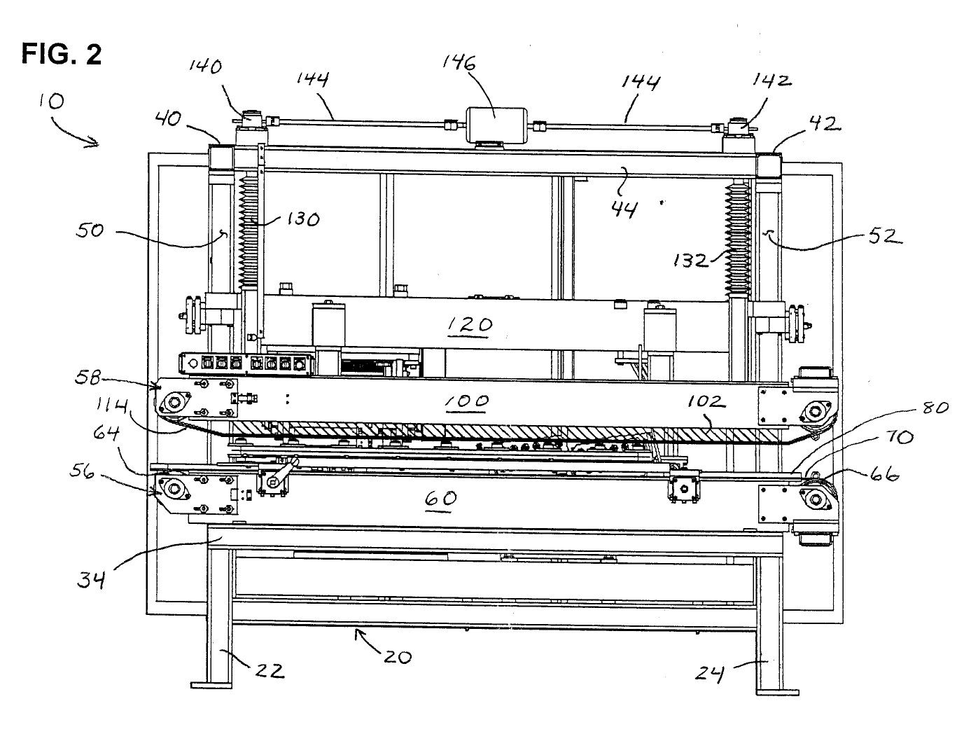

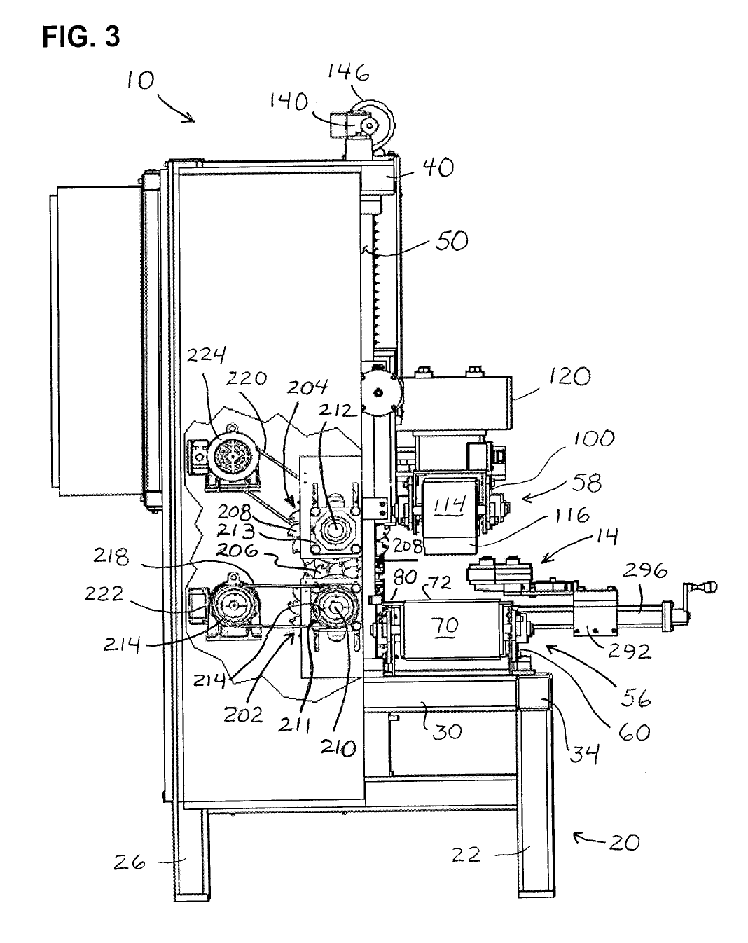

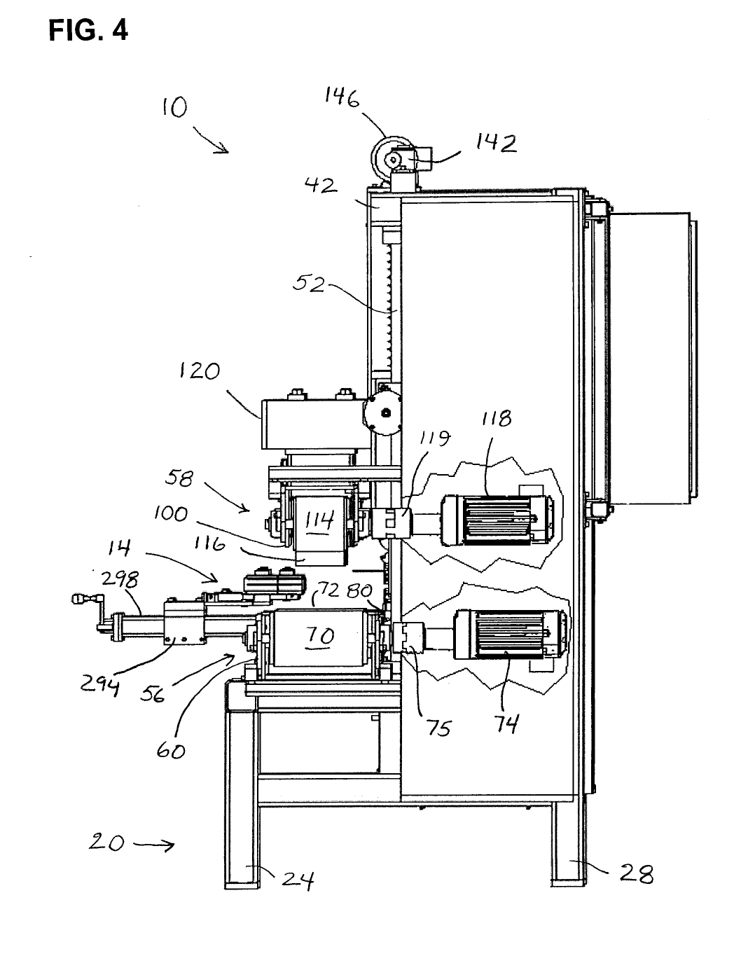

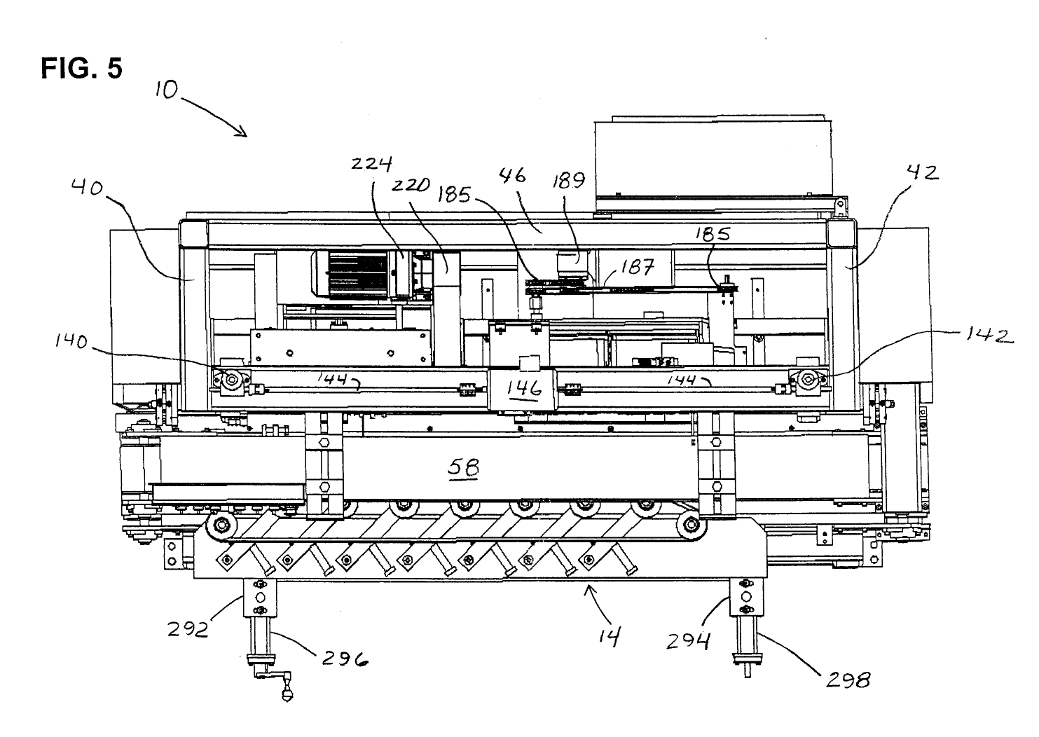

In a preferred embodiment, the machine 10 of the present invention comprises a main frame 20, a transport section 12, and a block modifying section 18. The main frame 20, as shown in FIGS. 1-4, includes a bed and a superstructure that are supported by a plurality of horizontal beams 30, 32, 34, 36, 40, 42, 44, 46 and vertical legs 22, 24, 26, 28. The superstructure extends vertically over the bed in a cantilevered fashion. The transport section 12, which includes a movable support portion 56 with a horizontal movable surface 84 and a stabilizer portion 58, are connected to the bed and the superstructure, respectively. Preferably, the stabilizer portion 58 may be selectively positioned in the vertical direction, relative to the movable support portion 56. This allows the transport section 12 to accommodate blocks having different sizes and shapes to be processed by the machine 10.

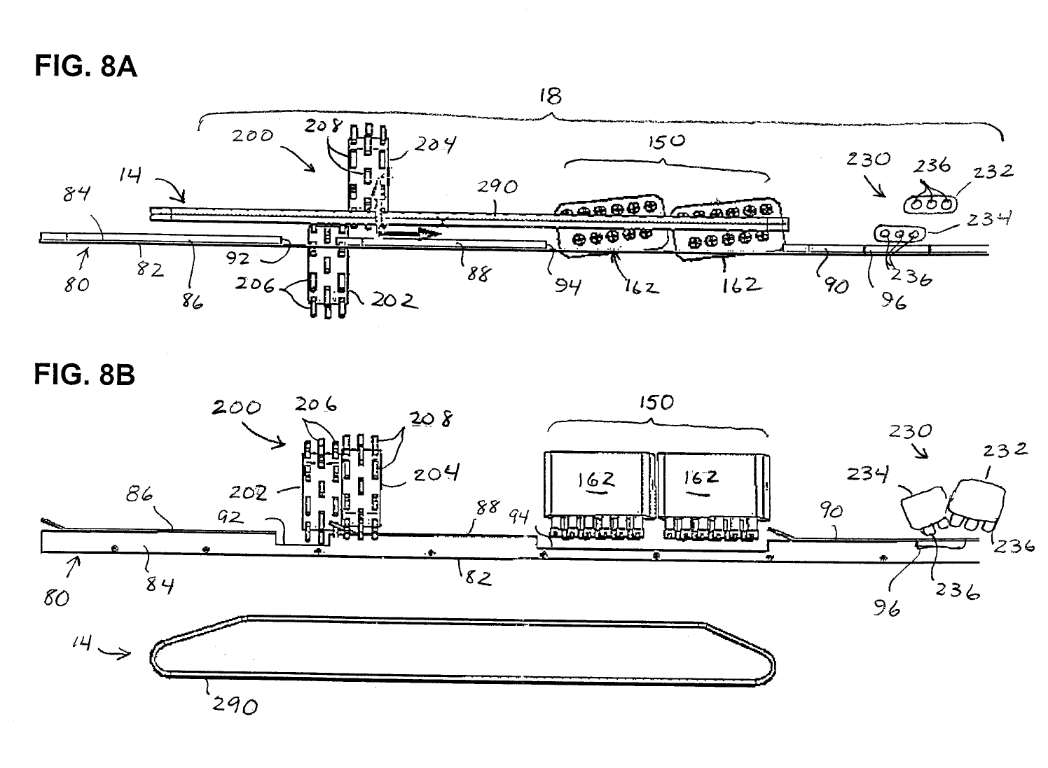

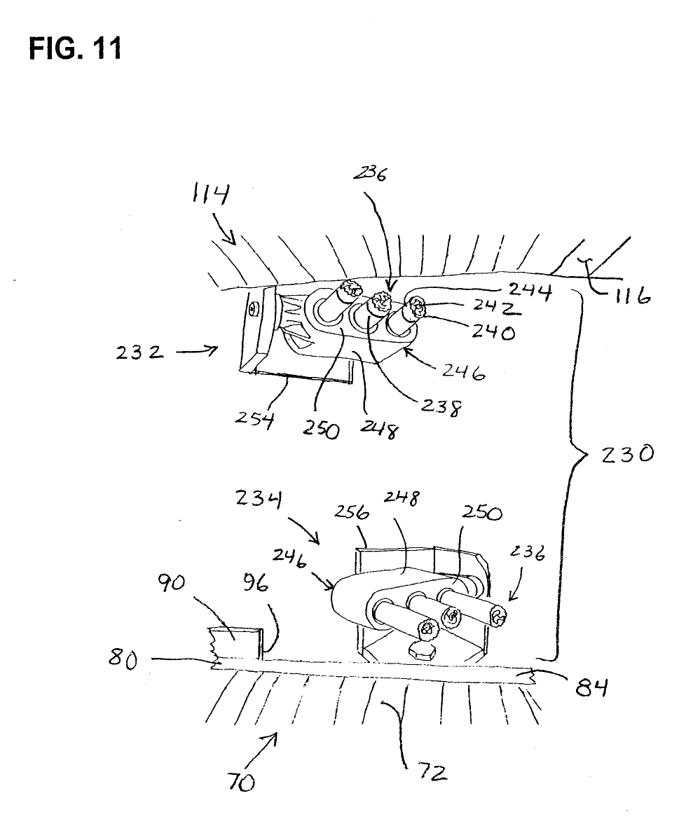

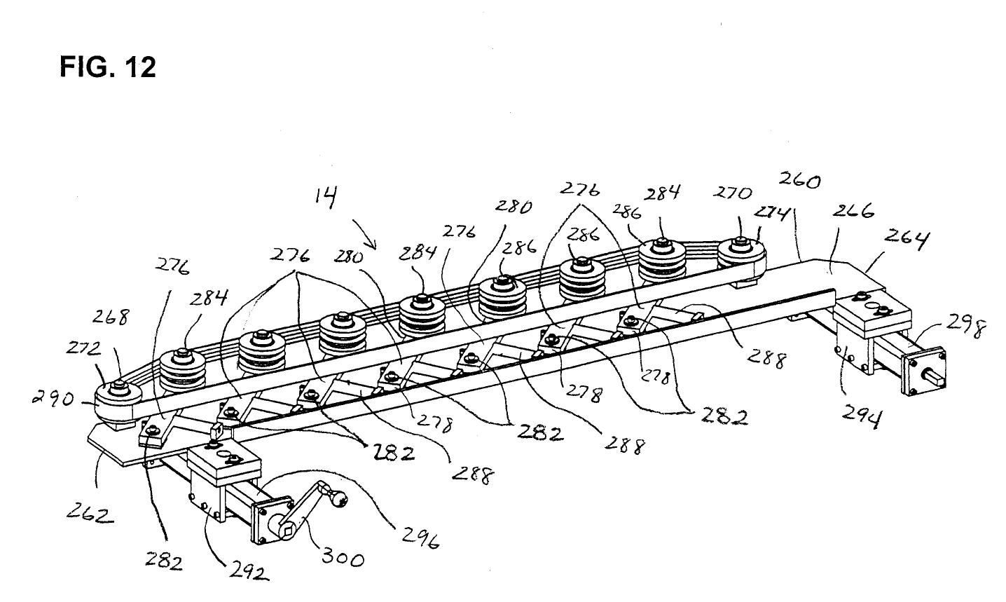

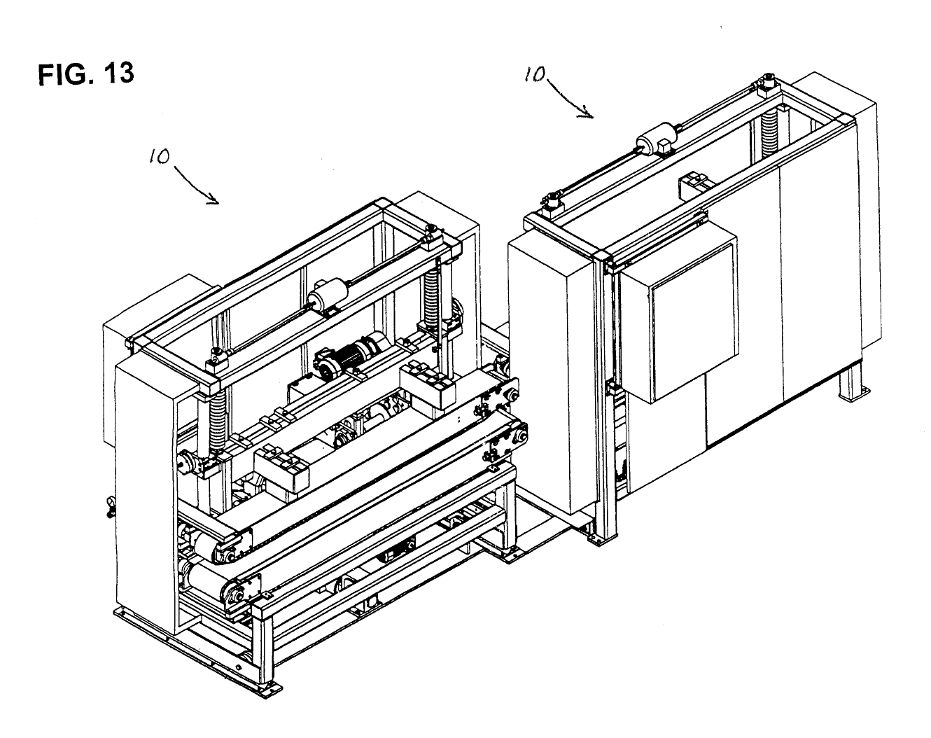

The preferred movable support portion 56 is a conveyor that includes an elongated box-shaped frame 60 with an upper surface (not shown) opposite ends that rotatably support cylindrically shaped rollers 64, 66, and an endless belt 70 is entrained about the upper surface and the rollers. The movable support portion 56 is movably powered by a conventional motive source 74 such as a hydraulic or electric motor and a coupler 75. The endless belt 70 is generally horizontal and is of sufficient width and length so as to be able to support one or more blocks placed thereon. A preferred inboard fence 80, located adjacent to one side of the movable support portion 56, serves as a guide for a block as it is moved through the machine 10 by the transport section 12. The inboard fence 80 comprises an elongated body 82 having planar horizontal upper surface 84 and a plurality of vertical walls 86, 88, 90, with the walls in longitudinal alignment with each other along the elongated body. Between the walls 86, 88, 90 of the inboard fence 80, there are gaps 92, 94, 96 that provide relief for portions of the block modifying section 18. As can be seen in FIGS. 8a, 8b, and 11, the gaps 92, 94, 96 enable teeth 208 of rotatable drum 204 and hammer elements 152 and 236 of impacting units 162 and 234, respectively, to engage selected portions of a viewable surface of a block.

The preferred stabilizer portion 58 is also a conveyor that includes an elongated box-shaped frame 100 with a lower surface (not shown), opposite ends that rotatably support cylindrically shaped rollers 110, 112, and an endless belt 114 is entrained about the lower surface and the rollers. The stabilizer portion 58 is movably powered by its own conventional motive source 118 such as a hydraulic or electric motor that is connected to the stabilizer portion 58 by a coupler 119. In use, the stabilizer portion 58 is positioned vertically, relative to the movable support portion 56 such that the outer (or bottom) surface of the belt 114 is able to contact upper surfaces of one or more blocks positioned on top of the movable support portion 56.

The stabilizer portion 58 is operatively connected to a horizontally oriented crossbeam or carriage 120 that is movably connected to the superstructure 48 of the main frame 20. The preferred crossbeam or carriage 120, which extends substantially along the length of the machine 10, includes opposing ends with vertically aligned apertures 122, 124, each of which slidingly receives a vertical guide column 50, 52 that is connected to the frame 20. The crossbeam or carriage 120 is connected to a pair of vertical jack screws 130, 132 (shown covered by flexible, protective tubes) that are rotatably mounted to the superstructure 48, and which extend downwardly into threaded apertures 126, 128 at the ends of the crossbeam 120. Both of the jack screws 130, 132 are operatively connected by gearing and drive shafts 144 to a single motive source 146 such as a hydraulic or electric motor. In operation the motive source 146 rotates the jack screws 130, 132 in concert, which, in turn, moves the crossbeam 120 (and the stabilizer portion 58 connected thereto) in a vertical direction, as desired.

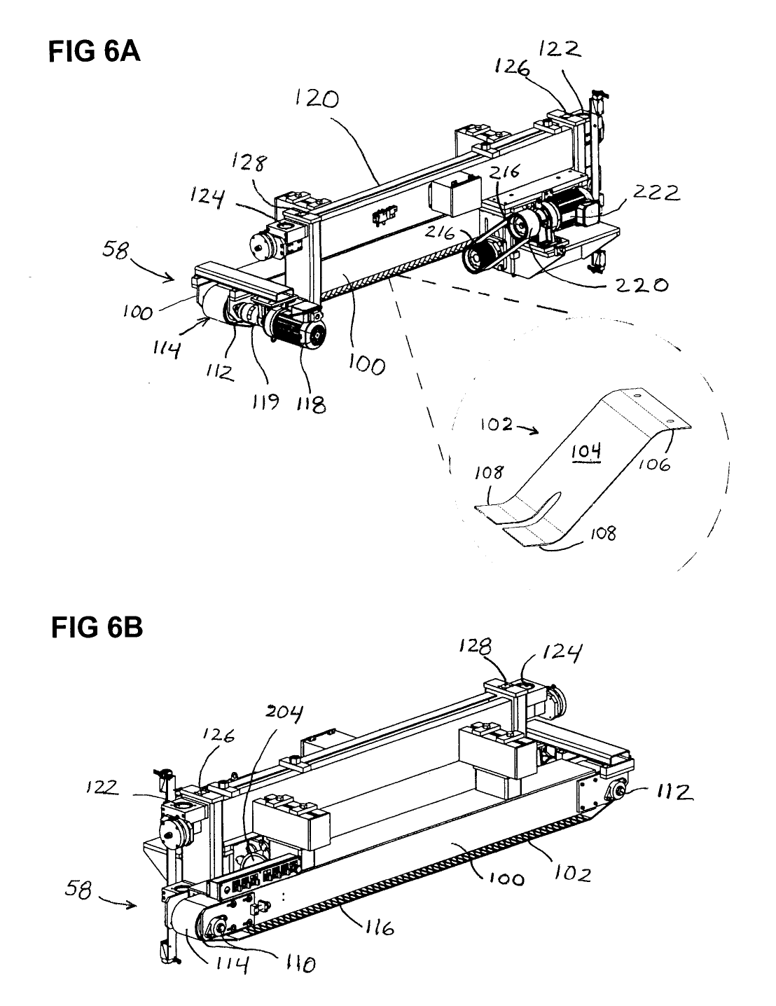

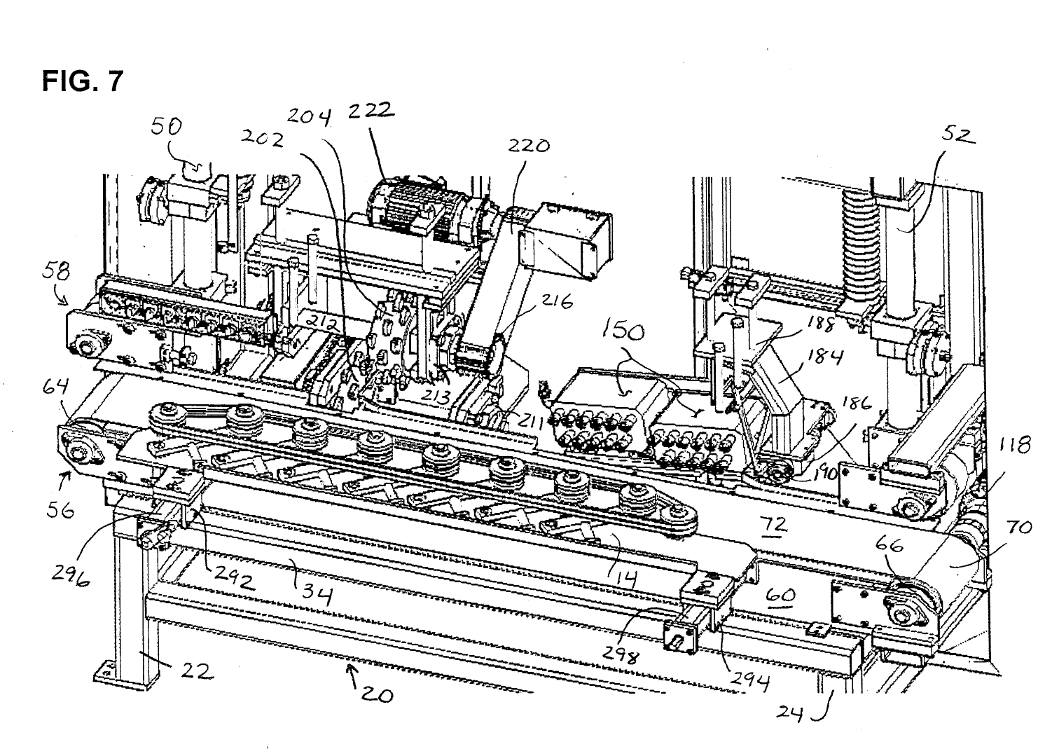

In operation, the movable support portion 56 and the stabilizer portion 58 are configured to contact external surfaces of one or more blocks as they move through the transport section 18. Preferably, the movable support portion 56 and the stabilizer portion 58 are configured to contact opposing external surfaces of a block so as to effectively grip a block being processed. The gripping ability of the transport section 18 is enhanced by providing the stabilizer portion 58 with one or more biasing elements 102 that exert a force towards the movable support portion 56. A preferred biasing element 102 is in the form of a resilient panel 104 having a generally z-shaped cross-section, with the panel having an upper arm segment 106, a diagonally oriented body, and a lower leg segment 108, is shown in an inset in FIG. 6A. In use, the upper arm segment 106 is preferably connected to the stabilizer portion 58 so that it faces the input end of the transport section 18 and the lower leg segment 108, which bears against the inside surface 73 of the conveyor belt 70, faces towards the output end of the transport section 12. Preferably, there is a plurality of resilient panels 104, arranged in a sequential order between the end rollers 110, 112, which bias a significant portion of the bottom surface of the belt 114 of the stabilizer portion 58 towards the movable support portion 56. If a block having a vertically extending protrusion (such as, for example, an interlocking lip on the bottom surface of an inverted block) passes through the transport section 12, the biasing elements 102 will automatically compensate for such variation, and the belt 114 will be able to maintain contact with the block. Other types of biasing elements 102 may be used. For example, resiliently mounted rollers. In operation, the belts 70, 114 of the movable support portion 56 and the stabilizer portion 58 preferably move at the same speed, which can range from about 0-to-100 feet per minute.

Generally, the block modifying section 18 is located to one side of the transport section 12 and comprises one or more primary modifiers 150 and one or more secondary block modifiers 200, 230. A preferred primary modifier 150 is a generally rectangularly shaped housing 162 having an exterior surface 164 with a top, a bottom, sides, a back and a front. The rectangular housing 162 forms a modifying unit or module 150 that is used to work a major, viewable surface of a block. To that end, the modifying unit or module 150 is provided with one or more hammer elements 152 that are movably connected thereto, and which protrude from apertures 168 in the front 166 of the modifying unit. Preferably, there are approximately 7 to approximately 15 hammer elements 152 in each modifying unit or module 150, with the hammer elements arranged into a pattern or matrix. More preferably, each unit or module 150 includes 11 hammer elements 152 arranged in two offset rows.

The housing 162 is operatively connected to a frame or platform 170 so that the hammer elements 152 face the transport section 12. The platform 170 may be adjusted in one of several directions, relative to the transport section 12. That is, the platform 170 may be adjusted so that the hammer elements 152 are able to be repositioned towards and away from the transport section 12, as desired. A preferred adjustment mechanism comprises a pair of jack screws that are operatively connected to the main frame 20 and which drivingly engage the platform 170 so that it may move relative to the transport section 12. Preferably, the jack screws are connected to each other by way of sprockets 185 and a chain 187 so that they are able to operate in concert. A motive source 189 such as a hydraulic or electric motor may be used to power the adjustment mechanism. As the hammer elements 152 are moved closer to the transport section 12, the amount of block material that can be removed increases.

Additionally, the platform 170 may be adjustably angled, relative to the transport section 12. To facilitate such adjustability, one end 172 of the platform 170 is pivotally connected to a shaft 182 that extends perpendicularly from the movable support portion 56. The other end 172 of the platform is operatively connected to the stabilizer portion 58 by way of a link 184. The link 184 compensates for changes in the distance between the movable support portion 56 and stabilizer portions 58. Moreover, as the stabilizer portion 58 is raised and lowered the platform 170 will pivot about the horizontal shaft 182 and automatically position the hammer elements 152 relative to the transport section 12. In operation, the platform 170 has a preferred angular range of about 0 to about 25 degrees.

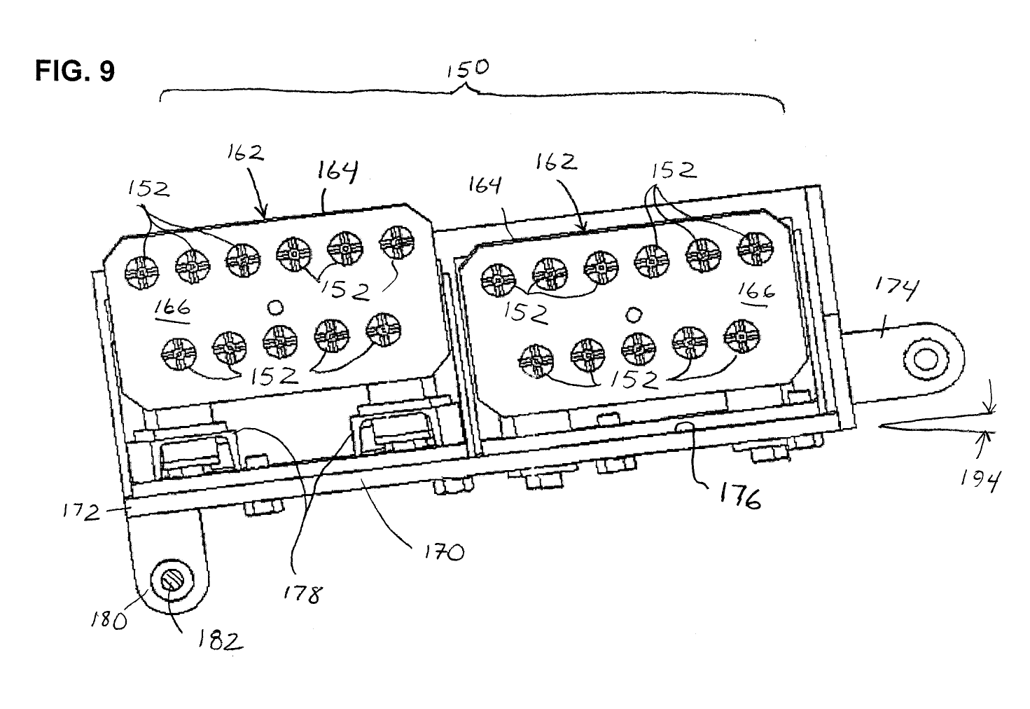

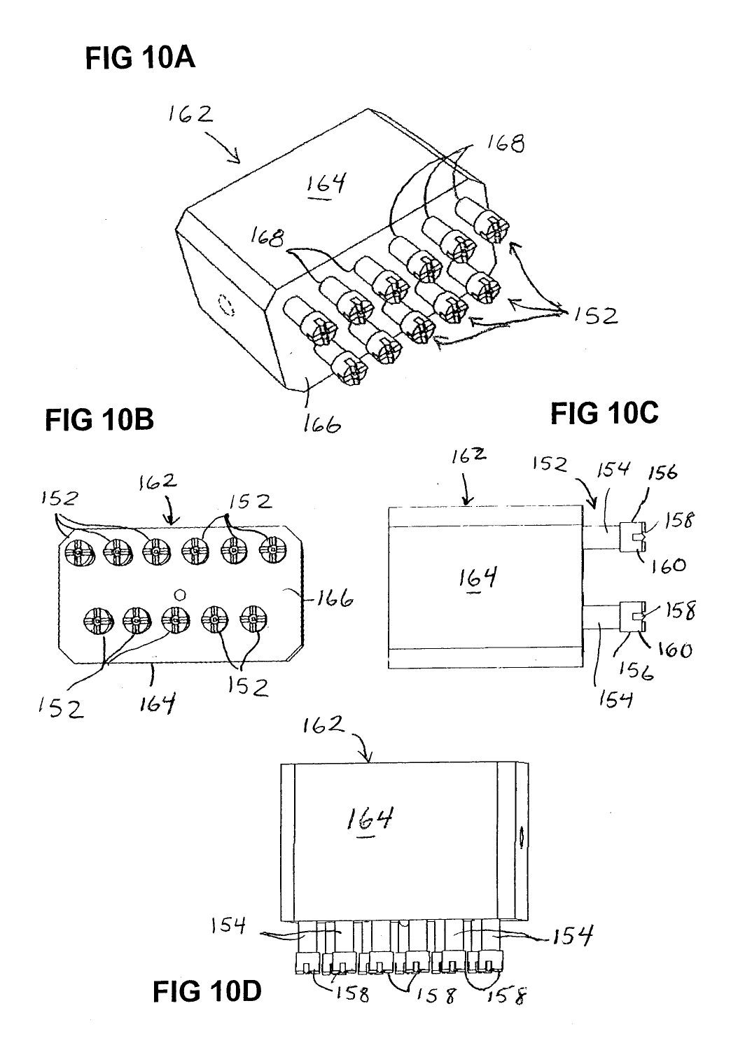

Preferably, two or more units or modules 150 positioned adjacent each other in a side-by-side relation on the platform 170. As shown in FIG. 9, the modifying units 150 are attached to the platform 170 at different elevations. It has been discovered that such an arrangement enables the impact zones of the hammer element to overlap, producing a more uniformly rustic-appearing surface. Preferably, one of the primary modifiers 150 is provided with spacers or blocks 178 interposed between the upper surface 176 of the platform 170 and the bottom surface of the primary modifier housing 162. The two units 150 act in concert with each other and are arranged so that they are in a vertically staggered relation so that the impact zones of the hammer elements 152 overlap.

Each preferred hammer element 152 has a shaft 154 having a diameter 155 of about 1.00 inch (2.54 cm), and includes one end that is operatively connected to a drive source such as a pneumatic drive source. The other end of the shaft 154 has a removable working end 156, which may have one of several differently shaped impacting surfaces. For example, the impacting surface 156 may be substantially flat, hemispherical, or may include a plurality of projections that terminate in flats and points. Each hammer element 152 reciprocates, and preferably, each hammer element has a stroke that varies by as much as 1.50 inches (3.82 cm). This enables the hammer elements 152 to work planar surfaces as well as surfaces that have convexities and concavities. Preferably, each hammer element 152 has an operational cycle or vibrational speed of approximately 1,500 to 4,000 cycles per minute.

In operation each hammer element 152 independently strikes and impacts a surface of a block being moved by the transport section 12 of the machine 10. An advantage of such independent motion is that the hammer elements 152 are able to work and otherwise process block surfaces that include convex and concave surfaces. Preferred hammer elements 152 are available through Trelawny SPT Ltd., of 13 Highdown Road, Leamington Spa, Warwickshire, CV31 1XT, United Kingdom. It is understood, however, that other similar reciprocating devices may be used without departing from the spirit and scope of the invention.

The secondary modifiers 200 may dress or otherwise work the viewable edges or arrises of the block to produce irregular edges. A preferred secondary modifier 200 comprises first and second rotatable drums 202, 204. More specifically, each drum 202, 204 includes a body having a plurality of outwardly extending teeth 206, 208. The teeth 206, 208 may be attached to the body in a conventional manner, such as welding, or bolting. Alternatively, the teeth 206, 208 may be integral to the body. The first rotatable drum 202 is operatively connected to the main frame 20 of the machine 10 by a shaft 210 and adjustable pillow blocks 211. Note that the shaft 210 is substantially parallel to the longitudinal axis of the transport section 12. The first drum 202 is connected by conventional pulleys 214 and a drive belt 218 to a motive source 222 such as an electric or hydraulic motor. As depicted, the first drum 202 is adjacent the movable support portion 56 so that the teeth 206 of the first drum protrude into a gap 92 in the inboard fence 80. As will be understood, the position of the first drum 202, relative to the movable support portion 56, is adjustable closer to or further away from the movable support portion, which changes the extents to which the teeth 206 protrude through the gap 92 in the inboard fence 80.

The second rotatable drum 204 is operatively connected to the crossbeam or carriage 120 of the machine 10, also by a shaft 212 and pillow blocks 213. As with the shaft 210 that supports the first drum 202, the shaft 212 that supports the second drum 204 is substantially parallel to the longitudinal axis of the transport section 12. The second drum 204 is connected by conventional pulleys 216 and a drive belt 220 to a motive source 224 such as an electric or hydraulic motor. As depicted, the second drum 204 is adjacent the stabilizer portion 58. Note that an upper, inboard fence is not needed. The pillow blocks 213 to which the shaft 212 is connected, may be adjustable so that the second drum 204 can be adjusted relative to the stabilizer portion 58. Although it is possible to arrange the first and second drums 202, 204 so that their respective teeth are vertically aligned with each other, it is advantageous to position the first and second drums so that the teeth are offset from each other in the longitudinal direction of the transport section 12. In operation, the second drum 204, which is connected to the stabilizer portion 58 of the transport section 12, automatically adjusts to differently sized blocks as the stabilizer portion is raised and lowered. Preferably, the rotatable drums 202, 204 work several disparate, viewable sections of a block before the block reaches the primary modifiers 150. It will be understood, however, that the rotatable drums 202, 204 may be positioned at other locations on the machine 10 without departing from the spirit and scope of the invention.

Another embodiment of a preferred secondary modifier 230 includes one or more sub-units or sub-modules 232, 234 that each have one or more hammer elements 236 acting generally perpendicular to the longitudinal axis of the transport section 12. Each sub-unit or module 232, 234 includes a plurality of hammer elements 236 arranged in a matrix or array. The hammer elements 236 are attached to a housing 246, which is movably attached to a bracket 254, 256. The bracket 254, 256 may also be adjustably positioned relative to the transport section 12. Thus, each sub-unit or module 232, 234 may be positioned in a plurality of orientations and positions relative to the transport section 12.

Each sub-unit or module may include approximately 1 to approximately 5 hammer elements. However, it is preferred that each sub-unit or module include approximately 2 to approximately 4 hammer elements. As with the primary modifiers 150 discussed above, each preferred hammer element 236 of the secondary modifiers 232, 234 has a shaft 238 having a diameter 239 of about 1.00 inch (2.54 cm), and includes one end operatively connected to a drive source such as a pneumatic drive source. The other end of the shaft 238 has a removable working end 240, which may have one of several differently shaped impacting surfaces. Each hammer element 236 reciprocates and preferably, each hammer element has a stroke that varies by as much as 1.50 inches (3.82 cm). Preferably, each hammer element 236 has an operational cycle or vibrational speed of approximately 1,500 to 4,000 cycles per minute.

Preferably, there are two or more sub-units or modules 232, 234 that can be adjustably positioned so that they are able to work one or more arrises or edges of a block. In operation each hammer element 236 independently strikes and impacts a surface of a block being moved by the transport section 12 of the machine 10. The sub-units or modules 232, 234 are operatively connected by way of brackets 254 to locations adjacent the movable support 56 and stabilizer portions 58 of the transport section 12, respectively. Preferably, the sub-units or modules 232, 234 work surfaces of a block after the block passes the primary modifiers 150. However, it will be understood that the sub-units or modules 232, 234 may be positioned before the primary modifiers 150, if desired. An advantage of such independent motion is that the hammer elements 236 are able to work and otherwise process block surfaces that include convex and concave surfaces. Preferred hammer elements are available through Trelawny SPT Ltd., of 13 Highdown Road, Leamington Spa, Warwickshire, CV31 1XT, United Kingdom. It is understood, however, that other similar reciprocating devices may be used with out departing from the spirit and scope of the invention.

The machine 10 may be provided with an outboard fence or fences 14 that may be connected to the movable support 56 and/or the stabilizer portions 58, respectively. In a preferred embodiment, a lower outboard fence 14 includes a plate 260 with an upper horizontal surface 266 having two ends 262, 264. At each end 262, 264 of the plate 260 there is a vertical shaft 268, 270 about which a rotatable element 272, 274 such as a wheel or pulley is mounted. In the space between the end wheels 272, 274, the plate 260 supports a plurality of horizontally oriented arms 276. One end of each arm 278 is pivotally connected to vertical shafts 282 extending from the plate 260, and the other end 280 of each arm 276 is provided with a vertical shaft 284 that supports a rotatable element 286, such as a wheel or pulley. Each arm 276 is operatively connected to a spring element 288 that biases the arm 276 in a predetermined direction towards one side of the plate 260. A belt 290 is positioned about the rotatable elements 286 and held in tension due to the effect of the spring-biased arms 276. In use, the lower fence 14 is positioned adjacent to and slightly above the horizontal surface 266 of the movable support portion 56 so that the belt 290 (and the spring biased rotatable elements 286) is able to contact the rear surfaces of one or more blocks as they are being processed by the machine 10. Note that the wheeled ends of the arms 280 preferably trail the pivoted ends 278 of the arms 276.

The lower fence 14 may include a pair of transversely oriented, horizontal sleeves 292, 294 that are attached to a lower surface of the plate 260. The sleeves are movably mounted to horizontally struts 296, 298 that extend from the movable support portion 56 of the transport section 12. Each strut includes a jack screw that engages internal threads of each sleeve. The jack screws are connected to each other by sprockets and a chain, with one of the ends of the jack screws including a crank arm or similar mechanism. The lower fence 14 may be moved towards and away from the transport section 12 so as to accommodate different sized blocks.

In an alternative embodiment, the lower outboard fence may comprise an elongated body that includes first and second ends, a first or horizontal wall, and a second or vertical wall. The outboard fence includes one or more rearwardly extending arms that may be operatively connected to horizontal struts 296, 298 that are connected to the main frame 20 through the movable support portion 56. Preferably, the outboard fence is movably positionable relative to the horizontal struts 296, 298 so that the distance between the lower, outboard fence and the inboard fence 80 can be varied to accommodate blocks having different depths (the z dimension in a three dimensional coordinate system).

The machine may also be provided with an optional upper outboard fence that comprises an elongated body that includes first and second ends, a first or horizontal wall and a second or vertical wall. The upper fence may include a third wall that is connected to the first and second walls, and which is angled relative thereto. The third wall presents a surface that can guide a block by contacting an upwardmost extending rear edge thereof. The upper, outboard fence includes one or more rearwardly extending arms with upwardly extending posts that may be operatively connected to horizontal struts by way of tubular brackets. The horizontal struts are preferably connected to the carriage or cross beam 120, to which the stabilizer portion 58 of the transport section 12 is connected. The position of the elongated body may be adjusted in the y and z directions in a three dimensional coordinate system to accommodate blocks having different heights and depths. Optionally, an adjustment mechanism comprising sprockets and a chain is operatively connected to jack screws in the horizontal struts. This allows the upper fence to be moved towards and from the stabilizer portion 58 in a substantially parallel manner.

The foregoing is considered as illustrative only. Furthermore, since numerous modifications and changes will readily occur to those skilled in the art, the exact construction and operation shown and described is only an example of a preferred embodiment. The invention is defined by the following claims.

What is claimed is:

1. A machine for modifying a surface of a building block, the machine comprising:
a block transport section that comprises:
a substantially horizontally oriented movable support portion; and
a stabilizer portion spaced vertically from the movable support portion, which biases a block carried by the movable support portion towards the movable support portion;
and
a block modifying section that comprises:
a primary modifier having at least one reciprocating hammer element acting substantially orthogonal to the block.

2. The machine of claim 1, further comprising an inboard fence between the movable support portion and the stabilizer portion that guides a block as it is moved by the transport section.

3. The machine of claim 2, further comprising an outboard fence that biases the block towards the inboard fence.

4. The machine of claim 3, wherein the outboard fence comprises an elongated member located adjacent the transport section and substantially parallel to the inboard fence, the elongated member configured and arranged to engage a block as it is moved by the transport section.

5. The machine of claim 4, wherein the elongated member includes an endless belt, the endless belt engaged by at least one wheel that is connected to the elongated member, the endless belt configured and arranged to engage a block as it is moved by the transport section.

6. The machine of claim 5, wherein a plurality of wheels is connected to the elongated member, and wherein the plurality of wheels engage the endless belt.

7. The machine of claim 5, wherein the at least one wheel is connected to the elongated member by an arm that is pivotally connected to the elongated member.

8. The machine of claim 7, wherein the arm is biased by a spring element.

9. The machine of claim 3, wherein the outboard fence is movably positionable relative to the transport section.

10. The machine of claim 1, wherein the movable support portion and the stabilizer portion are substantially parallel.

11. The machine of claim 1, wherein the movable support portion and the stabilizer portion are vertically positionable relative to each other.

12. The machine of claim 1, wherein the movable support portion is a conveyor belt.

13. The machine of claim 1, wherein the stabilizer portion is a conveyor belt.

14. The machine of claim 1, wherein the block modifying section further comprises a secondary modifier that engages a viewable edge of the block as it is moved by the transport section.

15. The machine of claim 14, wherein the secondary modifier is a rotatable drum having a radially extending tooth.

16. The machine of claim 14, wherein the secondary modifier is at least one reciprocating hammer element.

17. The machine of claim 14, wherein the secondary modifier comprises two sub-units vertically spaced from each other and positioned adjacent the support and stabilizer portions of the transport sections, respectively.

18. The machine of claim 17, wherein at lease one of the sub-units comprises a rotatable chipper drum.

19. The machine of claim 17, wherein at lease one sub-unit comprises a hammer element configured and arranged for reciprocal movement relative to the longitudinal axis of the transport section.

20. The machine of claim 1, wherein the hammer element is movably positionable relative to the support portion and the stabilizer portion.

21. The machine of claim 1, wherein the hammer element is operatively connected to the movable support portion and the stabilizer portion, and wherein position of the hammer element is automatically adjusted as the movable support and stabilizer portions are adjusted vertically.

22. The machine of claim 1, wherein the primary block modifying section comprises a plurality of hammer elements.

23. The machine of claim 1, further comprising a second primary modifier having at least one reciprocating hammer element acting substantially orthogonal to an externally viewable surface of the block.

24. The machine of claim 23, wherein the second primary modifier comprises a plurality of hammer elements.

25. A machine for modifying a surface of a block, the machine comprising:
a block transport section and a block modifying section;
wherein the block modifying section comprises:
a reciprocating hammer element, with the hammer element positionable in one of several orientations relative to the transport section

26. The machine of claim 25, wherein the block modifying section comprises a plurality of hammer elements, with at least two of the hammer elements reciprocally movable relative to the transport section.

27. The machine of claim 26, wherein the hammer elements are configured and arranged to strike a block at different elevations relative to the transport section as the block is moved the transport section from an input end to an output end.

28. The machine of claim 25, wherein the hammer elements are configured and arranged to strike the viewable surface of the block in a random manner.

29. The machine of claim 26, wherein each hammer element has a working end having an impact area, and wherein the working ends of the hammer elements are positioned so that the impact areas of the respective working ends are able to overlap each other on the viewable surface of a block as it is being moved through the machine by the transport section.

30. A machine for modifying a surface of a block, the machine comprising:
a transport section that comprises:
a movable support portion having a substantially horizontal surface;
and
a block modifying section that comprises a hammer element configured and arranged for reciprocal motion in a direction that is substantially orthogonal to the block transport section.

31. The machine of claim 30, wherein the block modifying section comprises a primary modifier unit and a secondary modifier unit, with the primary modifier unit configured and arranged to work a substantially planar, viewable surface of a block of material as it is moved through the machine by the transport section, and wherein the secondary modifier unit is configured and arranged to work a viewable edge of the block of material as it is moved through the machine by the transport section.

32. The machine of claim 31, wherein the secondary modifier unit comprises a reciprocating hammer element.

33. The machine of claim 31, wherein the secondary modifier unit comprises a rotatable drum having a radially extending tooth.

34. The machine of claim 30, wherein the transport section further comprises a stabilizer portion positioned above the horizontal surface of the movable support portion, the stabilizer configured and arranged to exert a biasing force towards the horizontal surface of the movable support portion, whereby a block being moved by the transport section is effectively gripped by the transport section.

35. The machine of claim 30, wherein the transport section further comprises an inboard fence located adjacent one side of the transport section, the inboard fence configured and arranged to engage a portion of a block of material as it is being moved by the transport section.

36. The machine of claim 35, further comprising an outboard fence located adjacent an opposite side of the transport section, the outboard fence configured and arranged to engage a non-viewable surface of a block as it is being moved by the transport section.

37. The machine of claim 36, wherein the outboard fence is configured and arranged to be able to exert a biasing force towards the inboard fence.
